(19) United States
(12) Patent Application Publication
(10) Pub. No.: US 2011/0064501 A1
(43) Pub. Date: Mar. 17, 2011

(54) SHEET-MEMBER TRANSPORT DEVICE AND IMAGE FORMING APPARATUS

(75) Inventors: Takahito Chiba, Kanagawa (JP); Toshiyuki Miyata, Kanagawa (JP); Masaru Funayanagi, Kanagawa (JP); Tohru Inoue, Kanagawa (JP); Atsumi Kurita, Kanagawa (JP); Toshinori Sasaki, Kanagawa (JP); Satoshi Nakamura, Kanagawa (JP)

(73) Assignee: Fuji Xerox Co., Ltd.,, Tokyo (JP)

(21) Appl. No.: 12/832,625

(22) Filed: Jul. 8, 2010

(30) Foreign Application Priority Data
Sep. 12, 2009 (JP) 2009-279640

(51) Int. Cl. G03G 15/00

(52) U.S. Cl. 399/400

(57) ABSTRACT

A sheet-member transport device includes an endless belt that is an endless band member formed by arranging fibers substantially in the form of a mesh, a surface at an outer periphery side of the endless belt being treated with surface processing so that the surface at the outer periphery side has a higher friction coefficient than a friction coefficient of a surface at an inner periphery side of the endless belt; and at least two rotary members, the endless belt being wound around the rotary members, the rotary members being rotated to move the endless belt around the two rotary members.

### CROSS-REFERENCE TO RELATED APPLICATIONS

This application is based on and claims priority under 35 USC 119 from Japanese Patent Application No. 2009-279640 filed Dec. 9, 2009.

### BACKGROUND

The present invention relates to a sheet-member transport device and an image forming apparatus.

SUMMARY

According to an aspect of the invention, there is provided a sheet-member transport device including an endless belt that is an endless band member formed by arranging fibers substantially in the form of a mesh, a surface at an outer periphery side of the endless belt being treated with surface processing so that the surface at the outer periphery side has a higher friction coefficient than a friction coefficient of a surface at an inner periphery side of the endless belt; and at least two rotary members, the endless belt being wound around the rotary members, the rotary members being rotated to move the endless belt around the two rotary members.

### BRIEF DESCRIPTION OF THE DRAWINGS

Exemplary embodiment(s) of the present invention will be described in detail based on the following figures, wherein:

FIG. 1 is a perspective view showing a sheet-member transport device according to an exemplary embodiment of the invention;

FIG. 2 is a perspective view showing the sheet-member transport device according to the exemplary embodiment of the invention;

FIG. 3 is a perspective view showing the sheet-member transport device according to the exemplary embodiment of the invention;

FIG. 4 is a perspective view showing the sheet-member transport device according to the exemplary embodiment of the invention;

FIG. 5 is a perspective view showing the sheet-member transport device according to the exemplary embodiment of the invention;

FIG. 6 is a perspective view showing the sheet-member transport device according to the exemplary embodiment of the invention;

FIGS. 7A and 7B are enlarged plan views each showing an endless belt used in the sheet-member transport device according to the exemplary embodiment of the invention;

FIG. 8 is a plan view showing the sheet-member transport device according to the exemplary embodiment of the invention;

FIG. 9 is a perspective sectional view showing the sheet-member transport device according to the exemplary embodiment of the invention;

FIG. 10 is a perspective sectional view showing the sheet-member transport device according to the exemplary embodiment of the invention;

FIG. 11 is a perspective sectional view showing the sheet-member transport device according to the exemplary embodiment of the invention;

FIG. 12 is a perspective sectional view showing the sheet-member transport device according to the exemplary embodiment of the invention;

FIG. 13 is a perspective sectional view showing the sheet-member transport device according to the exemplary embodiment of the invention;

FIG. 14 is a perspective view showing another sheet-member transport device according to the exemplary embodiment of the invention;

FIG. 15 is a perspective view showing the sheet-member transport device according to the exemplary embodiment of the invention;

FIG. 16 is a table showing air volumes of a fan used in the sheet-member transport device according to the exemplary embodiment of the invention;

FIG. 17 is a side view showing the sheet-member transport devices according to the exemplary embodiment of the invention;

FIG. 18 is a schematic configuration diagram showing an image forming unit used in an image forming apparatus according to the exemplary embodiment of the invention; and

FIG. 19 is a schematic configuration diagram showing the image forming apparatus according to the exemplary embodiment of the invention.

### DETAILED DESCRIPTION

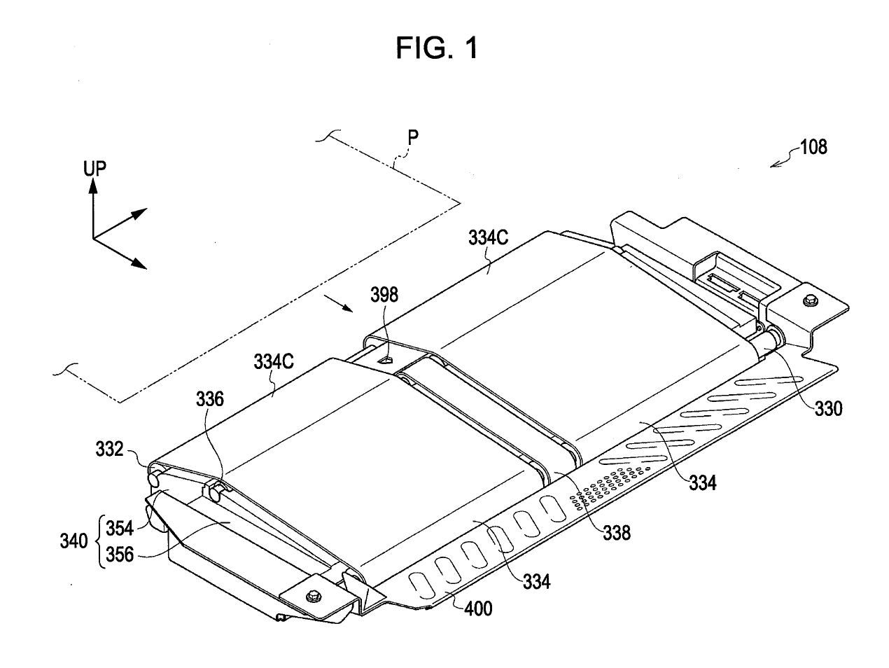

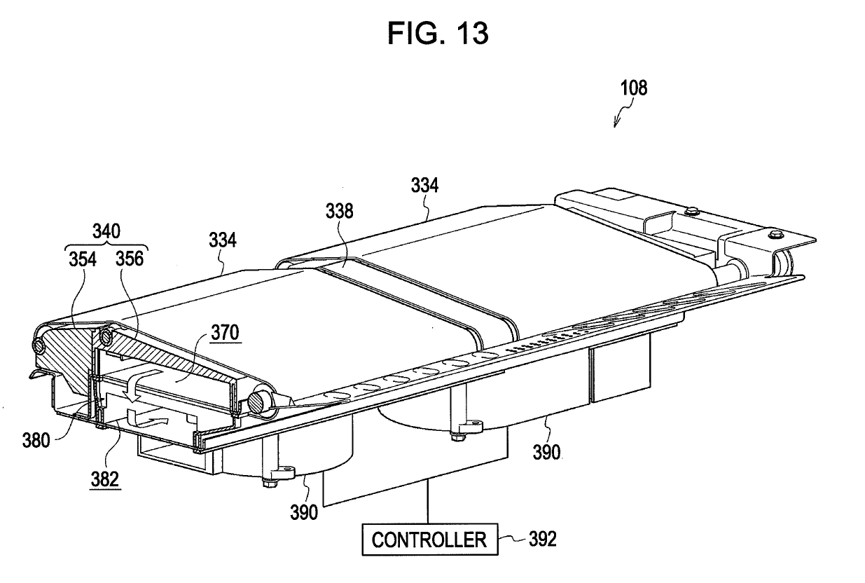

Sheet-member transport devices and an image forming apparatus according to an exemplary embodiment of the present invention will be described below with reference to FIGS. 1 to 19. In the figures, arrow UP indicates upward in a vertical direction.

### General Configuration

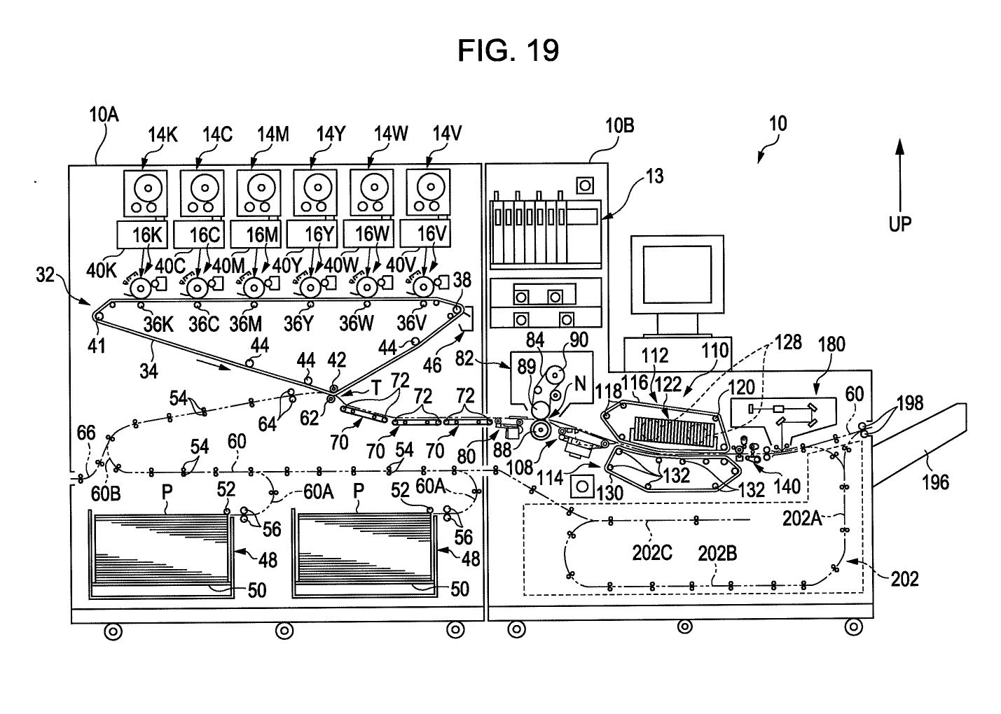

An image forming apparatus 10 according to the exemplary embodiment forms a full-color image or a monochrome image. Referring to FIG. 19, the image forming apparatus 10 includes a first housing 10A and a second housing 10B. The first housing 10A houses a first processing unit that is a portion at one side in a horizontal direction (at a left side in FIG. 19). The second housing 10B is detachably connected with the first housing 10A and houses a second processing unit that is a portion at the other side in the horizontal direction (at a right side in FIG. 19).

An image signal processor 13 is provided in an upper portion of the second housing 10B. The image signal processor 13 performs image processing on image data that is sent from an external device, such as a computer.

Toner cartridges 14V, 14W, 14Y, 14M, 14C, and 14K that respectively house toners of a first special color (V), a second special color (W), yellow (Y), magenta (M), cyan (C), and black (K) are detachably provided in an upper portion of the first housing 10A and arranged along the horizontal direction.

The first and second special colors may be selected from colors including a transparent color, except the yellow, magenta, cyan, and black. Also, in the following description, characters of V, W, Y, M, C, and K follow the reference numerals of components if the components for the first special color (V), second special color (W), yellow (Y), magenta (M), cyan (C), and black (K) are distinguished. The characters V, W, Y, M, C, and K are omitted if the components for the first special color (V), second special color (W), yellow (Y), magenta (M), cyan (C), and black (K) are not distinguished.

Six image forming units 16 are provided respectively below the toner cartridges 14 and arranged in the horizontal direction correspondingly to the toner cartridges 14.

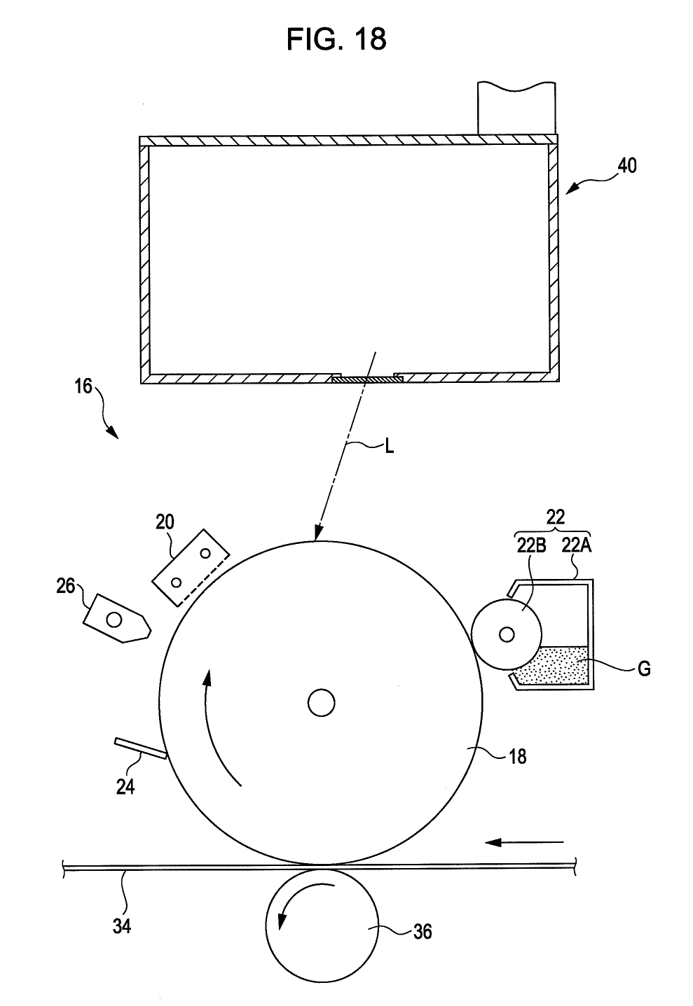

Optical scanning devices 40 are provided respectively for the image forming units 16. The optical scanning devices 40 receive image data, on which the image processing has been performed by the image signal processor 13, and irradiate image bearing members 18 (described later) with light beams L, which have been modulated in accordance with the image data (see FIG. 18).

Referring to FIG. 18, each image forming unit 16 includes the image bearing member 18 that is rotationally driven in one direction (clockwise in FIG. 18). When each optical scanning device 40 irradiates the corresponding image bearing member 18 with the light beam L, an electrostatic latent image is formed on the image bearing member 18.

A scorotron charging device 20, a developing device 22, a blade 24, and a discharging device 26 are provided around each image bearing member 18. The scorotron charging device 20 is of corona discharge type (non-contact charging type). The scorotron charging device 20 is an example of a charging device that charges the image bearing member 18 with electricity. The developing device 22 develops the electrostatic latent image formed on the image bearing member 18 by the optical scanning device 40, with a developer. The blade 24 serves as a removing member that removes the developer remaining on the image bearing member 18 after transferring. The discharging device 26 irradiates the image bearing member 18 with light after the transferring, to discharge the electricity from the image bearing member 18.

The scorotron charging device 20, the developing device 22, the blade 24, and the discharging device 26 face the surface of the image bearing member 18, and are arranged in that order from an upstream side to a downstream side in a rotation direction of the image bearing member 18.

The developing device 22 includes a developer container 22A and a development roller 22B. The developer container 22A contains a developer G including a toner. The development roller 22B supplies the image bearing member 18 with the developer G contained in the developer container 22A. The developer container 22A is connected with the toner cartridge 14 (see FIG. 19) through a toner supply path (not shown), so that the toner is supplied to the developer container 22A from the toner cartridge 14.

Referring to FIG. 19, a transfer unit 32 is provided below the image forming units 16. The transfer unit 32 includes a ring-like intermediate transfer belt 34 that is in contact with the image bearing members 18, and first transfer rollers 36 as first transfer members that transfer toner images formed on the image bearing members 18 onto the intermediate transfer belt 34 in a superposed manner.

The intermediate transfer belt 34 is wound around a driving roller 38 that is driven by a motor (not shown), a tension roller 41 that applies a tension to the intermediate transfer belt 34, an opposite roller 42 that faces a second transfer roller 62 (described later), and plural support rollers 44, so that the intermediate transfer belt 34 is moved in one direction (counterclockwise in FIG. 19) by the driving roller 38.

Each first transfer roller 36 faces the image bearing member 18 of the corresponding image forming unit 16 with the intermediate transfer belt 34 interposed therebetween. A feed unit (not shown) applies a transfer bias voltage to the first transfer roller 36. The transfer bias voltage has a polarity reverse to a toner polarity. With this configuration, the toner image formed on the image bearing member 18 is transferred on the intermediate transfer belt 34.

A discharging device 46 faces the driving roller 38 with the intermediate transfer belt 34 interposed therebetween. The discharging device 46 has a blade, and brings the blade into contact with the intermediate transfer belt 34 to remove, for example, a remaining toner and paper dust on the intermediate transfer belt 34.

Two recording medium containers 48 are provided below the transfer unit 32 and arranged in the horizontal direction. The recording medium containers 48 contain recording media P, such as sheets of paper, as an example of sheet members.

Each recording medium container 48 may be pulled out from the first housing 10A. A feed roller 52 is provided above a portion at one end (at the right side in FIG. 19) of each recording medium container 48. The feed roller 52 feeds the recording media P from the recording medium container 48 to a transport path 60.

Each recording medium container 48 has a bottom plate 50 therein, on which the recording media P are mounted. The bottom plate 50 is lowered upon an instruction from a controller (not shown) when the recording medium container 48 is pulled out from the first housing 10A. Since the bottom plate 50 is lowered, the recording medium container 48 obtains a space for supplement of the recording media P by a user.

When the recording medium container 48 pulled out from the first housing 10A is inserted into the first housing 10A, the bottom plate 50 is lifted upon an instruction from the controller. Since the bottom plate 50 is lifted, the top one of the recording media P mounted on the bottom plate 50 contacts the feed roller 52.

A separation roller 56 is provided at a downstream side in a transport direction of the recording medium P (hereinafter, also merely referred to as “downstream side”) with respect to the feed roller 52. The separation roller 56 separates the recording media P one by one when the recording media P are double-fed from the recording medium container 48. Plural transport rollers 54 are provided downstream the separation roller 56. The transport rollers 54 transport the recording medium P to the downstream side in the transport direction.

The transport path 60 is provided between the recording medium container 48 and the transfer unit 32. The transport path 60 extends to a transfer position T between the second transfer roller 62 and the opposite roller 42 such that the recording medium P, which has been fed from the recording medium container 48, is returned at a first return portion 60A to the left side in FIG. 19 and then returned at a second return portion 60B to the right side in FIG. 19.

A feed unit (not shown) applies a transfer bias voltage to the second transfer roller 62. The transfer bias voltage has a polarity reverse to the toner polarity. With this configuration, the second transfer roller 62 secondarily transfers the toner images of the respective colors, which have been transferred on the intermediate transfer belt 34 in a superposed manner, on the recording medium P, which has been transported along the transport path 60.

A spare path 66 extends from a side surface of the first housing 10A to meet the transport path 60 at the second return portion 60B. A recording medium P fed from another recording medium container (not shown) arranged adjacent to the first housing 10A may be transported along the spare path 66 and enter the transport path 60.

Plural transport belts 70 are provided downstream the transfer position T. The transport belts 70 transport the recording medium P with the toner images transferred thereon to the second housing 10B. A sheet-member transport device 80 is provided in the second housing 10B. The sheet-member transport device 80 transports the recording medium P transported by the transport belts 70 to the downstream side.

Each of the plural transport belts 70 has a ring-like shape, and is wound around a pair of support rollers 72. One of the pair of support rollers 72 is arranged at an upstream side in the transport direction of the recording medium P (hereinafter, also merely referred to as “upstream side”) and the other is arranged at the downstream side. When either one of the pair of support rollers 72 is rotationally driven, the transport belt 70 is moved in one direction (clockwise in FIG. 19).

Then, the sheet-member transport device 80 provided at the downstream side in the transport direction of the recording medium P with respect to the transport belt 70 transports recording medium P to a fixing unit 82. The fixing unit 82 is an example of a fixer that fixes the toner images transferred on the surface of the recording medium P, to the recording medium P with heat and pressure.

The fixing unit 82 includes a fixing belt 84, and a pressure roller 88. The pressure roller 88 is arranged to contact the fixing belt 84 from below. A fixing portion N is defined between the fixing belt 84 and the pressure roller 88. The toner images are fixed by applying the heat and pressure to the recording medium P at the fixing portion N.

The fixing belt 84 has a ring-like shape, and is wound around a driving roller 89 and a driven roller 90. The driving roller 89 faces the pressure roller 88 from above. The driven roller 90 is arranged above the driving roller 89.

The driving roller 89 and the driven roller 90 respectively include built-in heaters such as halogen heaters, and hence the fixing belt 84 is heated.

Referring to FIG. 19, a sheet-member transport device 108 is provided at the downstream side in the transport direction of the recording medium P with respect to the fixing unit 82. The sheet-member transport device 108 transports the recording medium P output from the fixing unit 82.

The sheet-member transport device 80 and the sheet-member transport device 108 will be described later in more detail.

A cooling unit 110 is provided downstream the sheet-member transport device 108. The cooling unit 110 cools the recording medium P which has been heated by the fixing unit 82.

The cooling unit 110 includes an absorption device 112 that absorbs the heat of the recording medium P, and a pressure device 114 that presses the recording medium P against the absorption device 112. The absorption device 112 is provided at one side (an upper side in FIG. 19) and the pressure device 114 is provided the other side (a lower side in FIG. 19) with respect to the transport path 60.

The absorption device 112 includes a ring-like absorption belt 116 that contacts the recording medium P and absorbs the heat of the recording medium P. The absorption belt 116 is wound around a driving roller 120 and plural support rollers 118. The driving roller 120 transmits a driving force to the absorption belt 116.

A heat sink 122 is provided at an inner periphery side of the absorption belt 116. The heat sink 122 is formed of an aluminum material that contacts the absorption belt 116 by surface-to-surface contact and radiates the heat absorbed by the absorption belt 116.

Also, fans 128 are arranged at a back side of the second housing 10B (a far side in FIG. 19). The fans 128 remove the heat from the heat sink 122 and exhaust the hot air to the outside.

The pressure device 114 that presses the recording medium P against the absorption device 112 includes a ring-like pressure belt 130 that transports the recording medium P while pressing the recording medium P against the absorption belt 116. The pressure belt 130 is wound around plural support rollers 132.

A straightening device 140 is provided downstream the cooling unit 110. The straightening device 140 pinches and transports the recording medium P, and straightens curve (curl) of the recording medium P.

A sensor 180 is provided downstream the straightening device 140. The sensor 180 detects, for example, a toner density defect, an image defect, and an image position defect in the toner image fixed to the recording medium P.

The sensor 180 includes a light source that emits light to the recording medium P, and a sensing element, such as a charge coupled device (CCD) image sensor, that detects the light emitted on the recording medium P and reflected from the recording medium P to the upper side. Thus, the sensor 180 detects, for example, a toner density defect, an image defect, and an image position defect.

An output roller 198 is provided downstream the sensor 180. The output roller 198 outputs the recording medium P with an image formed on one side, to an output portion 196 that is attached to a side surface of the second housing 10B.

If images are to be formed on both sides, the recording medium P from the sensor 180 is transported to a reverse path 202 provided downstream the sensor 180.

The reverse path 202 includes a branch path 202A that is branched from the transport path 60; a sheet transport path 202B, along which the recording medium P transported along the branch path 202A is transported to the first housing 10A; and a reverse path 202C that returns the recording medium P transported along the sheet transport path 202B in the reverse direction, so that the recording medium P is switched back and the surfaces of the recording medium P are reversed.

With this configuration, the recording medium P, which has been switched back and transported along the reverse path 202C, is transported to the first housing 10A. The recording medium P enters the transport path 60 provided above the recording medium container 48, and is transported to the transfer position T again.

Next, an image forming process of the image forming apparatus 10 will be described.

Image data, on which the image processing is performed by the image signal processor 13, is sent to each optical scanning device 40. The optical scanning device 40 emits the light beam L in accordance with the image data, and exposes the corresponding image bearing member 18, which has been charged with electricity by the scorotron charging device 20, with light. Thus, the electrostatic latent image is formed.

Referring to FIG. 18, the electrostatic latent image formed on the image bearing member 18 is developed by the developing device 22. The toner images of the respective colors including the first special color (V), second special color (W), yellow (Y), magenta (M), cyan (C), and black (K) are formed.

Referring to FIG. 19, the toner images of the respective colors formed on the image bearing members 18 of the image forming units 16V, 16W, 16Y, 16M, 16C, and 16K are successively transferred on the intermediate transfer belt 34 in a superposed manner by the six first transfer rollers 36V, 36W, 36Y, 36M, 36C, and 36K.

The second transfer roller 62 secondarily transfers the toner images of the respective colors, which have been transferred on the intermediate transfer belt 34 in a superposed manner, on the recording medium P, which has been transported from the recording medium container 48. The recording medium P with the toner images transferred thereon is transported by the transport belt 70 to the fixing unit 82 provided in the second housing 10B.

The fixing unit 82 fixes the toner images of the respective colors on the recording medium P to the recording medium P by applying the heat and pressure to the toner images. The recording medium P with the toner images fixed thereto passes through the cooling unit 110. The cooling unit 110 cools the recording medium P. Then, the recording medium P is transported to the straightening device 140. The straightening device 140 straightens the curve generated at the recording medium P.

The sensor 180 detects an image defect or the like of the recording medium P with the curve thereof straightened. Then, the output roller 198 outputs the recording medium P to the output portion 196.

Meanwhile, when an image is to be formed on a surface on which no image is formed (in a case of duplex printing), the recording medium P is reversed at the reverse path 202 after the recording medium P has passed through the sensor 180. The recording medium P is transported to the transport path 60 provided above the recording medium container 48, and toner images are formed on the back surface of the recording medium P by the above-described process.

In the image forming apparatus 10 according to the exemplary embodiment, parts for forming images of the first and second special colors (image forming units 16V and 16W, optical scanning devices 40V and 40W, toner cartridges 14V and 14W, and first transfer rollers 36V and 36W) are detachably attached to the first housing 10A as optional parts depending on the user's choice. Hence, the image forming apparatus 10 may have a configuration without the parts for forming the images of the first and second special colors, or a configuration with the parts for forming the image of one of the first and second special colors.

### Configuration of Major Portion

Next, the sheet-member transport device 80 arranged upstream the fixing unit 82 will be described.

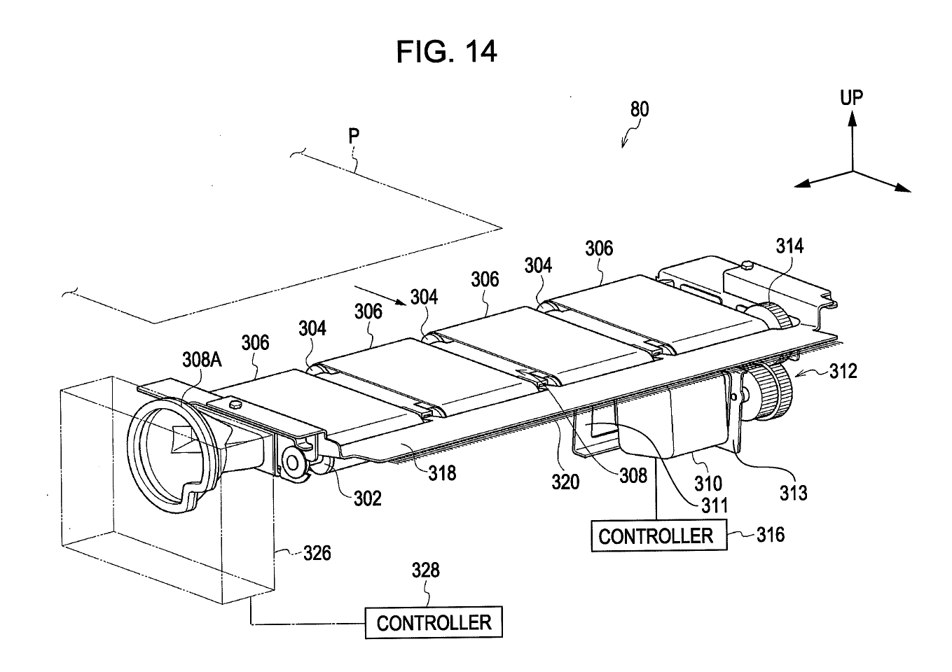

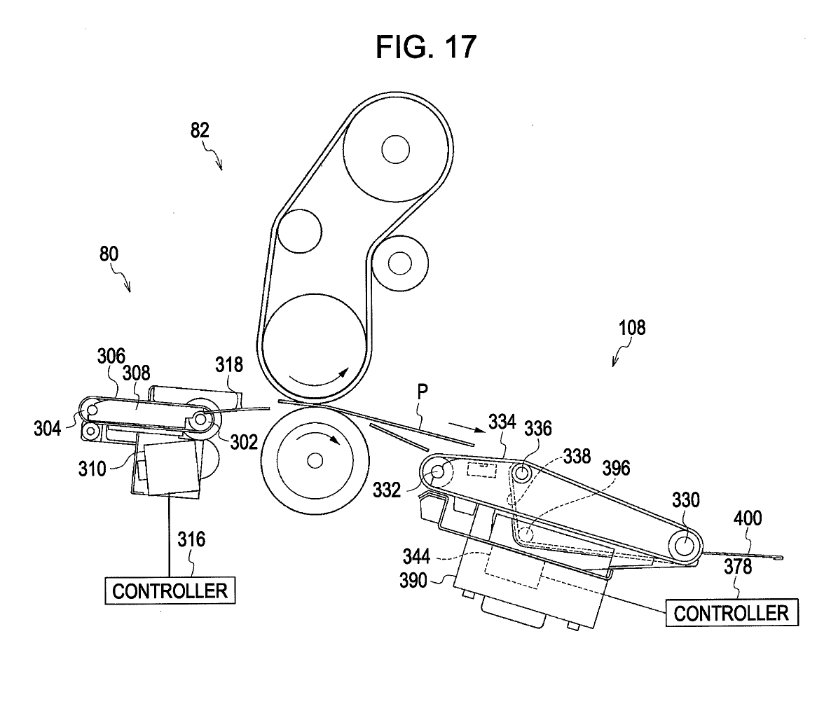

Referring to FIGS. 14 and 17, the sheet-member transport device 80 includes a driving roller 302 as an example of a driving member that is rotationally driven, a driven roller 304 as an example of a driven member that is provided downstream the driving roller 302 and rotatably supported, four endless belts 306 wound around the driving roller 302 and the driven roller 304, and a hollow air duct 308 arranged at an inner periphery side of the endless belts 306 and supporting the driven roller 304 at the upstream side. That is, rotary members that cause the endless belts 306 to move include the driving roller 302 and the driven roller 304. When the driving roller 302 is rotationally driven, the endless belts 306 are moved. Since the driven roller 304 contacts the moving endless belts 306, the driven roller 304 is rotated.

More specifically, the driven roller 304 that supports inner peripheral surfaces of the endless belts 306 is molded with a resin material. An outer peripheral portion of the driving roller 302 that supports the inner peripheral surfaces of the endless belts 306 is formed of a rubber material.

A motor 310 and a gear train 312 are provided below the endless belts 306. The motor 310 is an example of a drive source supported by a bracket 311 fixed to the air duct 308. The gear train 312 is supported by a bracket 313 fixed to the air duct 308 and by an output shaft 310A of the motor 310. A gear 314 is provided at one end portion of the driving roller 302. A driving force is transmitted to the gear 314 from the output shaft 310A of the motor 310 through the gear train 312.

Referring to FIG. 17, a controller 316 is provided as an example of a first controller that controls driving of the motor 310. The controller 316 drives the motor 310 during image formation in which an image is formed on a recording medium P (a sheet member), and drives the motor 310 also during image non-formation (a standby state) in which no image is formed on a recording medium P (a sheet member), to move the endless belts 306.

Also, referring to FIG. 14, a substantially circular opening portion 308A is provided at one end of the hollow air duct 308. The opening portion 308A is attached to an air inlet (not shown) of a fan 326 as an example of a suction member that is provided in the apparatus body and sucks the air.

Plural openings (not shown) are made in an upper surface of the air duct 308 facing the transported recording medium P with the endless belts 306 interposed therebetween. When the fan 326 in the apparatus body is operated, the air is sucked into the air duct 308 through the openings in the upper surface of the air duct 308.

A controller 328 is provided as an example of a second controller that controls the operation of the fan 326. The controller 328 operates the fan 326 during the image formation in which an image is formed on a recording medium P (a sheet member), and operates the fan 326 also during the image non-formation (the standby state) in which no image is formed on a recording medium P, so that the air is sucked into the air duct 308 through the openings in the upper surface of the air duct 308.

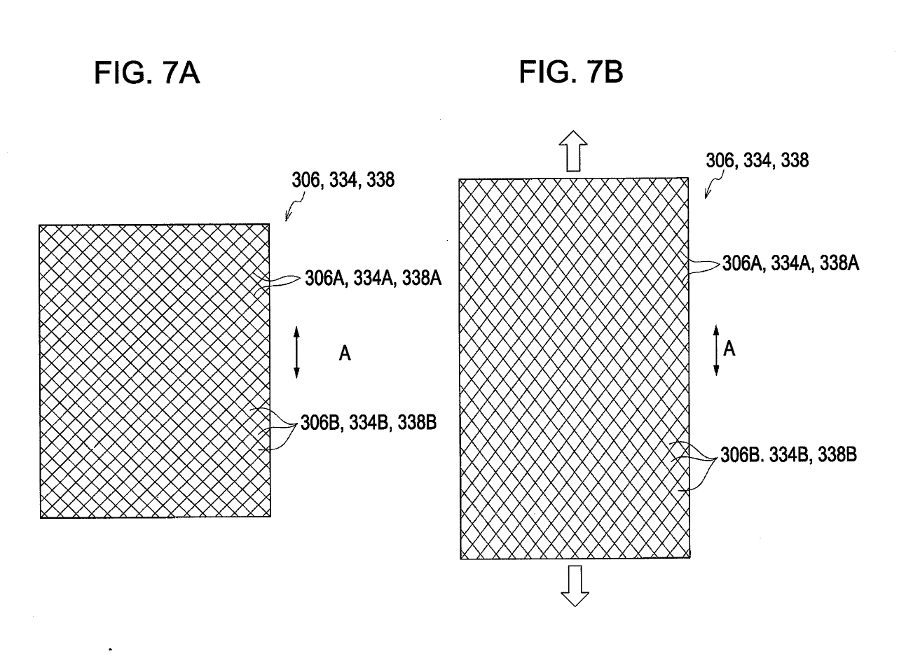

Referring to FIG. 7A, each endless belt 306 is a ring-like band member formed by weaving fibers 306A substantially in the form of a mesh (in the exemplary embodiment, 60 meshes/2.54 cm with a thickness of 280 μm and an opening area of 42%). The fibers 306A are molded with a resin material (in the exemplary embodiment, polyester resin with a line diameter of 150 μm). A weaving direction of the fibers 306A is oblique to the transport direction of the recording medium P (a direction indicated by arrow A in FIGS. 7A and 7B).

Since the weaving direction of the fibers 306A is oblique to the transport direction of the recording medium P, referring to FIG. 7B, the endless belt 306 is capable of stretching in the transport direction of the recording medium P. Also, since the endless belt 306 is substantially the mesh, a sucking force for sucking the air at an outer periphery side of the endless belt 306 into the air duct 308 through mesh holes 306B (openings) is substantially uniform over the outer peripheral surface of the endless belt 306. Unevenness in temperature of the recording medium P (the sheet member) due to the air sucked into the air duct 308 hardly occurs.

Joint portions generated when each endless belt 306 is formed into the ring-like shape are made by heat sealing to be oblique to the transport direction of the recording medium P.

Further, the outer peripheral surface of each endless belt 306 is treated with surface processing (in the exemplary embodiment, a material for the surface processing is urethane resin), so that the outer peripheral surface of the endless belt 306 has a higher friction coefficient with respect to the transported recording medium P than a friction coefficient of the inner peripheral surface of the endless belt 306. It is to be noted that only the outer peripheral surface is treated with the surface processing to prevent an increase in rotation load due to friction between the inner peripheral surface of the endless belt 306 and the air duct and the like arranged in the endless belt 306 because the surface processing is applied to the inner peripheral surface. The color of the surface processing is black. Thus, contamination resulted from the developer or the like is not noticeable, and since the color of the fibers 306A is white, the front and back surfaces of the endless belt 306 may be easily distinguished by the color difference.

Referring to FIGS. 14 and 17, a plate-like guide member 318 is provided downstream the endless belt 306. The guide member 318 guides the recording medium P transported by the endless belts 306 to the fixing unit 82. Also, a discharging brush 320 is provided at a distal end portion (a downstream end portion) of the guide member 318. The discharging brush 320 discharges electricity from the transported recording medium P.

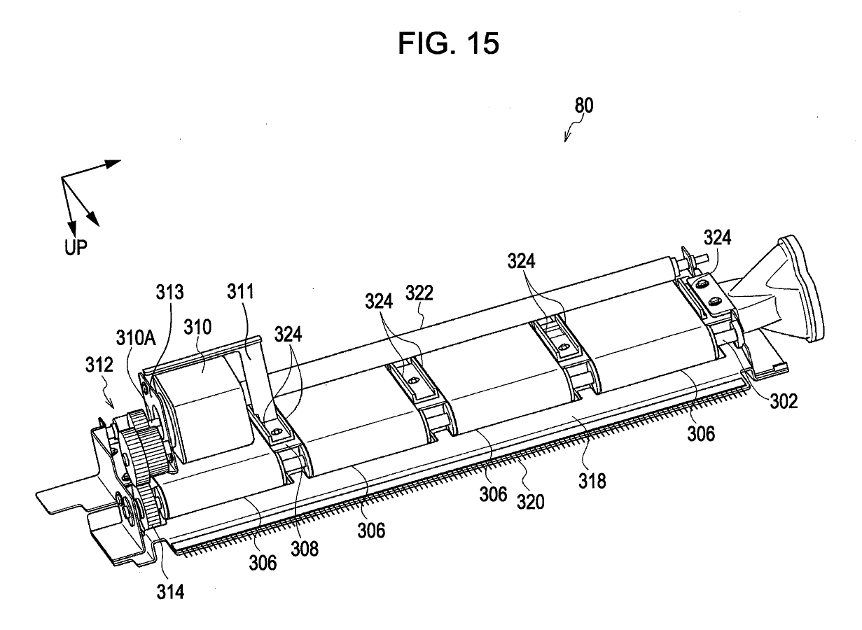

Referring to FIG. 15, a cleaning roller 322 is provided below the endless belts 306. The cleaning roller 322 is in contact with the outer peripheral surfaces of the endless belts 306 and is rotated thereby. The cleaning roller 322 cleans up the outer peripheral surfaces of the endless belts 306.

Further, limit members 324 protrude from a lower surface (a surface on which the recording medium P is not transported) of the air duct 308. The limit members 324 contact end portions of the endless belts 306 and limit movement of the endless belts 306 in a direction orthogonal to the transport direction of the recording medium P (a thrust direction).

Next, the sheet-member transport device 108 arranged downstream the fixing unit 82 will be described.

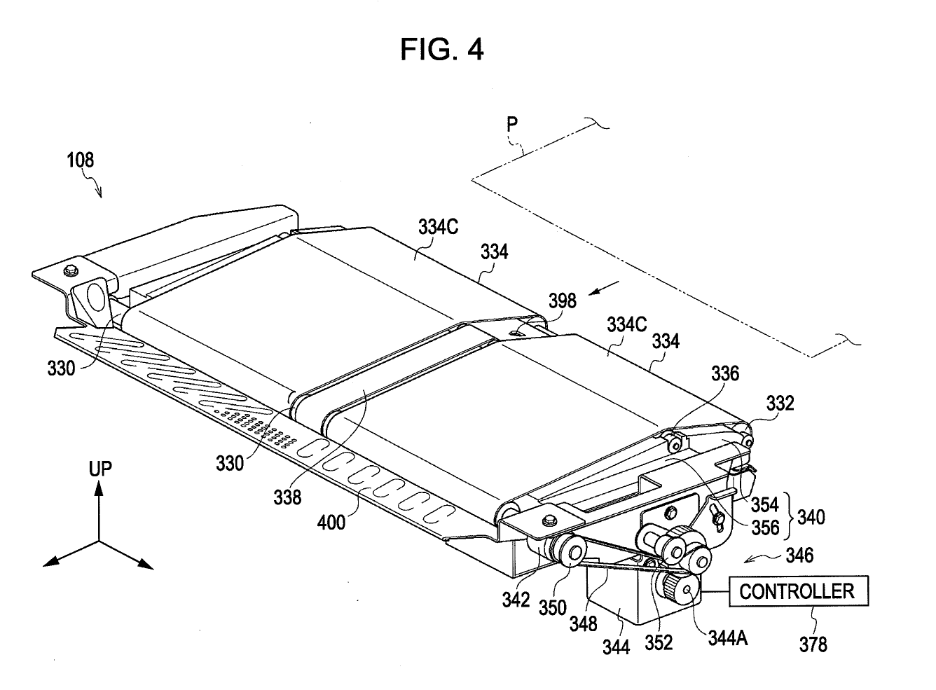

Referring to FIGS. 1 and 4, the sheet-member transport device 108 includes a driving roller 330 as an example of a driving member that is rotationally driven, a driven roller 332 as an example of a driven member that is provided upstream the driving roller 330 and rotatably supported, and two endless belts 334 wound around the driving roller 330 and the driven roller 332.

In addition, a driven roller 336 is provided between the driving roller 330 and the driven roller 332. The driven roller 336 contacts inner peripheral surfaces of the moving endless belts 334 and is rotationally driven by the endless belts 334. The driven roller 336 lifts upper surfaces (surfaces for transporting the recording medium P) of the endless belts 334 upward to incline entrance regions 334C for the recording medium P.

In other words, since the entrance regions 334C are provided, the upper surfaces of the endless belts 334 are inclined to the transport direction of the recording medium P sent from the fixing unit 82 such that a surface to be transported of the recording medium P gradually approaches the upper surfaces of the endless belts 334 toward the downstream side.

Further, an endless belt 338 is provided between the two endless belts 334. The endless belt 338 is wound around the driving roller 330 and the driven roller 336. A length of a transport surface for transporting the recording medium P of the endless belt 338 is smaller than a length of a transport surface for transporting the recording medium P of each endless belt 334. Rotary members that cause the endless belts 334 and 338 to move include the driving roller 330 and the driven rollers 332 and 336. The endless belt 338 has a smaller dimension in a width direction (a direction orthogonal to the transport direction of the recording medium P) than a dimension in the width direction of each endless belt 334.

Further, a hollow air duct 340 is provided at inner periphery sides of the endless belts 334 and 338.

Referring to FIGS. 1 and 4, the driven rollers 332 and 336 that support the inner peripheral surfaces of the endless belts 334 and 338 are molded with a resin material. An outer peripheral portion of the driving roller 330 that supports the inner peripheral surfaces of the endless belts 334 and 338 are formed of a rubber material. Also, a driving-force limit member 342 (for example, a torque limiter) is provided at one end portion of the driving roller 330. The driving-force limit member 342 is an example of a driving-force limit unit that limits transmission of a driving force of a motor 344. The motor 344 is an example of a drive source. Thus, a transport velocity at which the recording medium P is transported by the sheet-member transport device 108 follows a transport velocity at which the recording medium P is transported by the fixing unit 82 (see FIG. 17). Further, a pulley 350 is attached to the driving-force limit member 342. A driving force is transmitted from an output shaft 344A of the motor 344 provided below the air duct 340 to the pulley 350 through a gear train 346 and a driving-force transmitting belt 348.

A tension roller 352 is also provided. The tension roller 352 presses an outer peripheral surface of the driving-force transmitting belt 348 and applies a tension to the driving-force transmitting belt 348. The motor 344 is a stepping motor that is operated in synchronization with a pulse voltage. In this exemplary embodiment, the driving-force limit member 342 has a set value of 150 (mN·m) by taking into consideration a motor load torque and waving of the recording medium P.

A controller 378 is provided as an example of a controller that controls driving of the motor 344. The controller 378 controls driving of the motor 344 such that a set velocity of the sheet-member transport device 108 (a peripheral velocity of a belt), at which the recording medium P is transported, is higher by 0.5% than a set velocity of the fixing unit 82 (a peripheral velocity of a roller), at which the recording medium P is transported.

The air duct 340 arranged at the inner periphery side of the endless belts 334 and 338 includes an upstream air duct 354 arranged upstream the driven roller 336, and a downstream air duct 356 arranged downstream the driven roller 336.

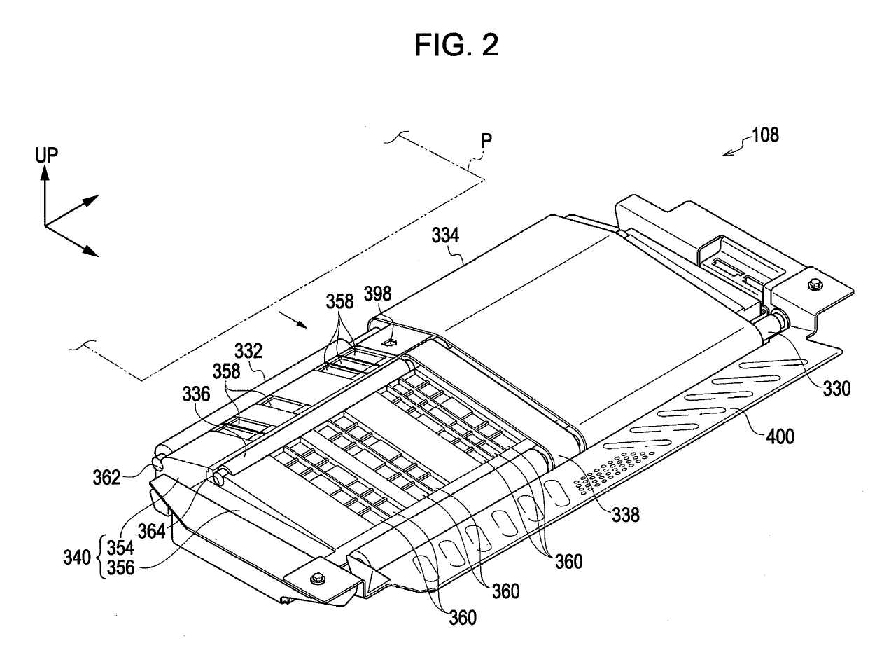

FIG. 2 illustrates the sheet-member transport device 108 when one of the endless belts 334 is removed. Referring to FIG. 2, the upstream air duct 354 that faces the transported recording medium P with the endless belt 334 interposed therebetween has plural openings 358 in an upper surface of the upstream air duct 354. Similarly, the downstream air duct 356 has plural openings 360 in an upper surface thereof.

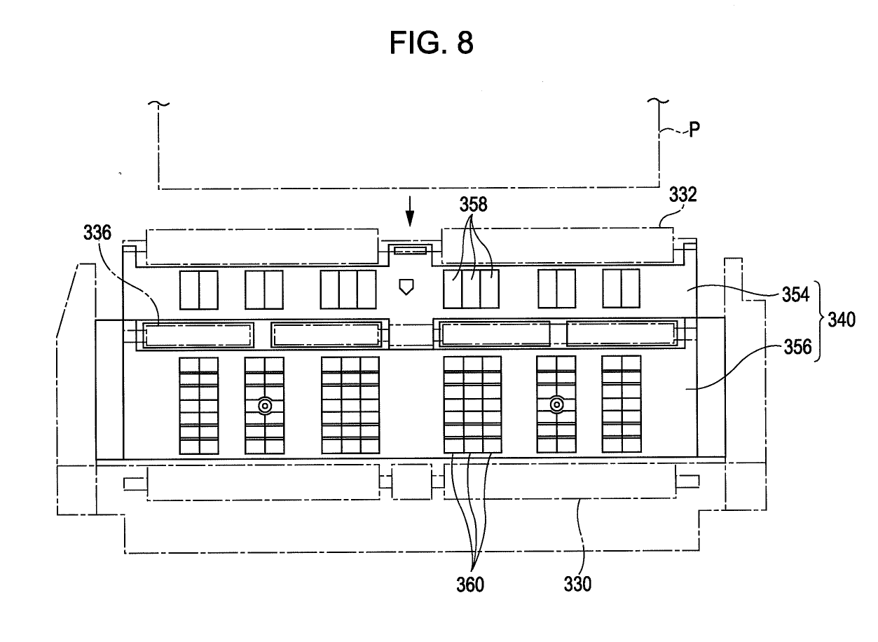

Referring to FIG. 8, the positions of the openings 358 and 360 are determined so that the recording medium P is capable of being sucked to the upper surfaces of the endless belts 334 and 338 without being loosened regardless of the size of the recording medium P.

Referring to FIG. 2, a recess 362 that supports the driven roller 332 is provided at an upstream end portion of the upstream air duct 354, and a recess 364 that supports the driven roller 336 is provided at an upstream end portion of the downstream air duct 356.

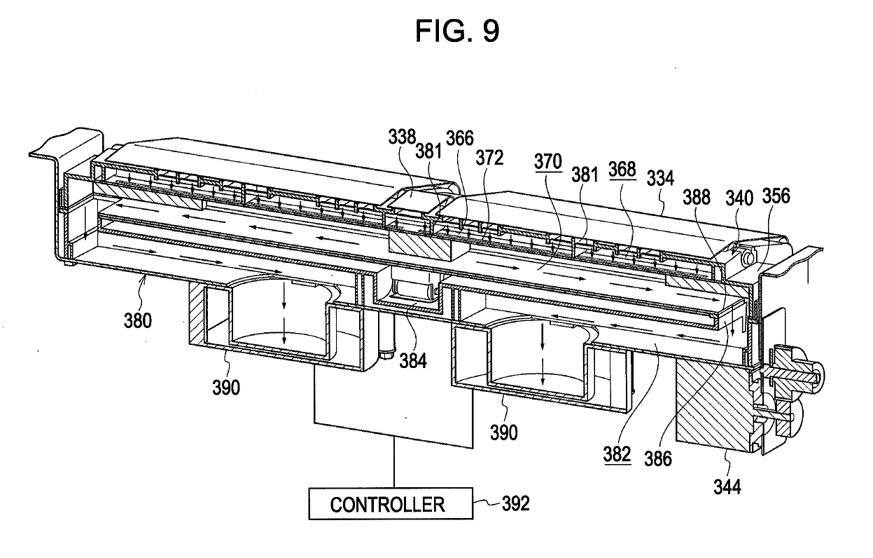

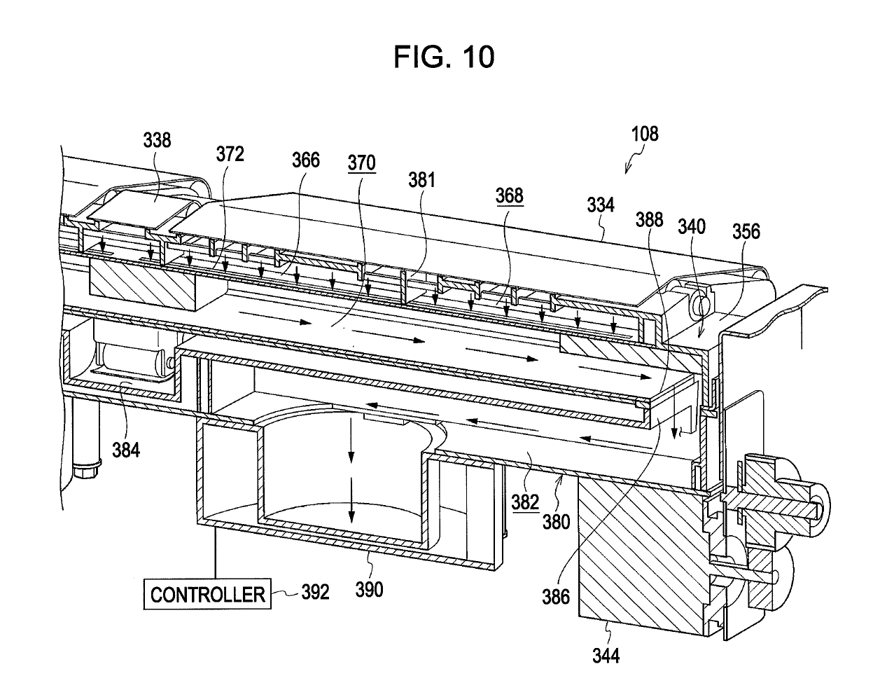

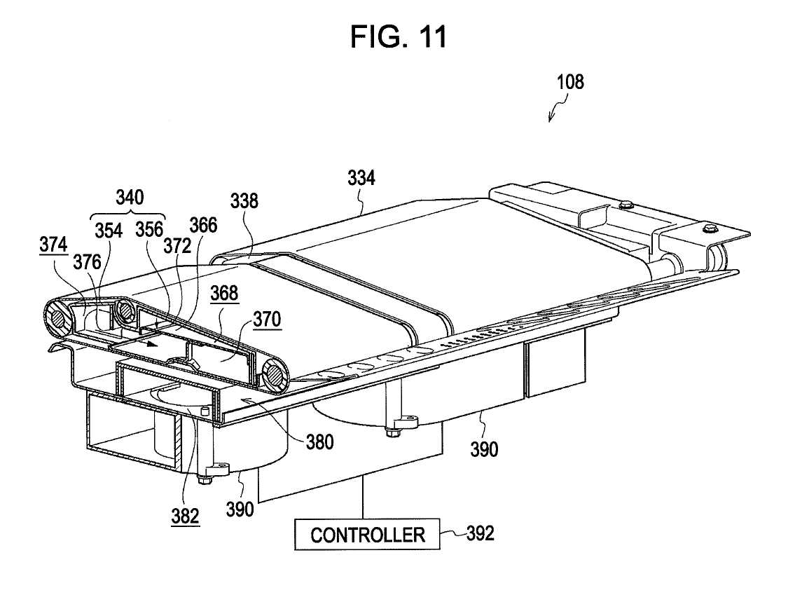

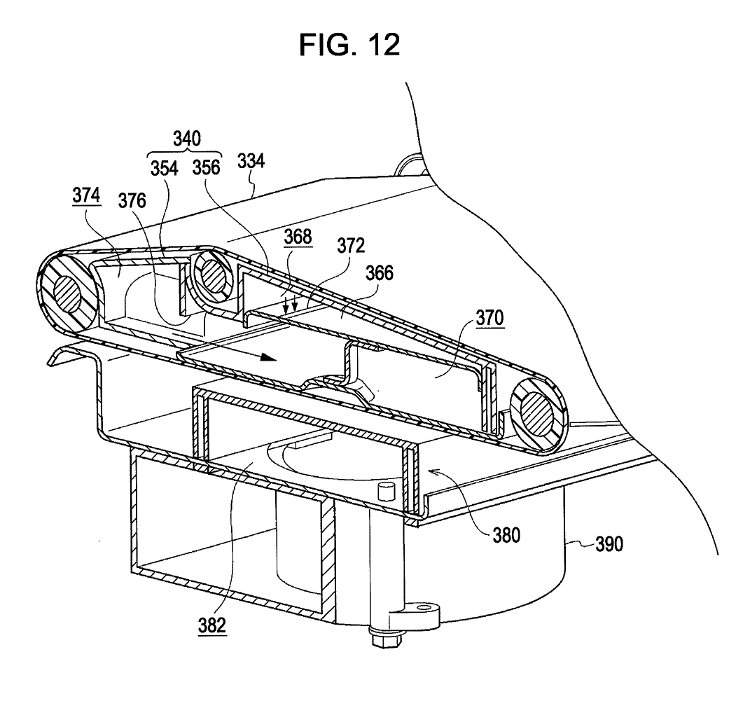

Referring to FIGS. 11 and 12, a rectifying plate 366 is provided in the downstream air duct 356. The rectifying plate 366 divides the inside space of the downstream air duct 356 into an upper space 368 and a lower space 370. The rectifying plate 366 has a slit 372 that extends in the direction orthogonal to the transport direction of the recording medium P and that allows the upper space 368 to communicate with the lower space 370. Referring to FIGS. 9 and 10, the upper space 368 is divided into plural space sections by plural partitions 381.

Referring to FIGS. 9, 10, 11, and 12, a hollow support member 380 is provided below the air duct 340 with lower surfaces of the endless belts 334 interposed therebetween. More specifically, the support member 380 is hollow, and has two spaces 382 arranged in the direction orthogonal to the transport direction of the recording medium P. A recess 384 whose top is open is provided between the two spaces 382 of the support member 380.

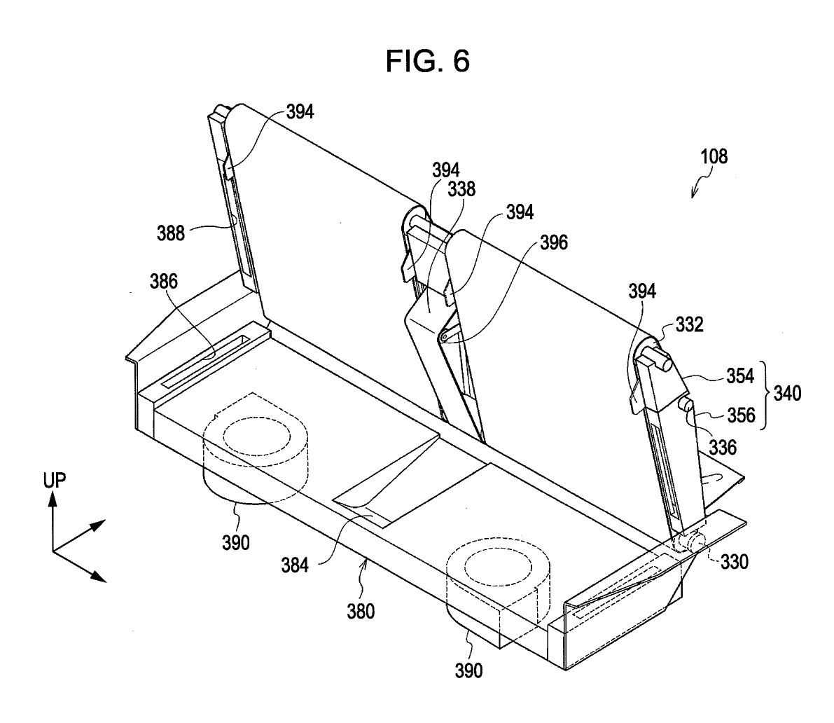

Openings 386 are provided at outer sides (at axial ends, see FIG. 6) of the upper surface of the support member 380. The spaces 382 are open through the openings 386. The downstream air duct 356 facing the openings 386 in the vertical direction has openings 388. The lower space 370 is open through the openings 388. Thus, the spaces 382 communicate with the lower space 370 through the openings 386 and 388.

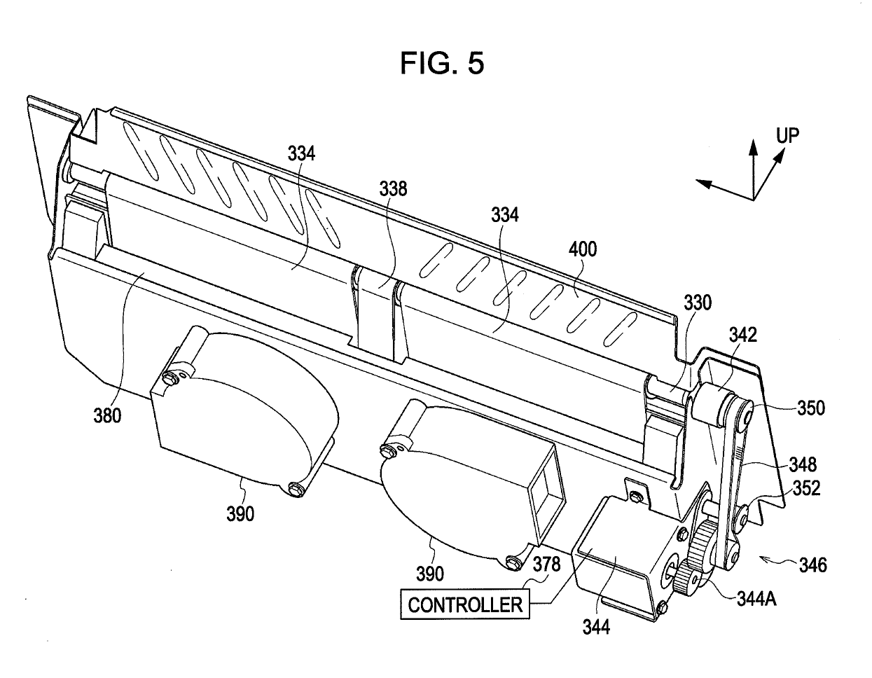

Fans 390 (see FIG. 5) are provided on a lower surface of the support member 380. The fans 390 each are an example of a suction member that sucks the air in the spaces 382.

Referring to FIGS. 9, 10, 11, 12, and 13, when the fans 390 are operated, the air around an upper surface of the upstream air duct 354 enters an upstream space 374 through the openings 358 (see FIG. 2), enters the lower space 370 through an opening 376, enters the spaces 382 through the openings 386 and 388, is sucked by the fans 390, and is exhausted to the outside.

The air around an upper surface of the downstream air duct 356 enters the upper space 368 through the openings 360 (see FIG. 2), enters the lower space 370 through the slit 372 provided in the rectifying plate 366, enters the spaces 382 through the openings 386 and 388, is sucked by the fans 390, and is exhausted to the outside. Accordingly, the recording medium P is attracted to the outer peripheral surfaces of the endless belts 334 and 338.

The shape of the slit 372 provided in the rectifying plate 366 is adjusted such that an attracting force generated at the upper surface of the upstream air duct 354 is greater than an attracting force generated at the upper surface of the downstream air duct 356.

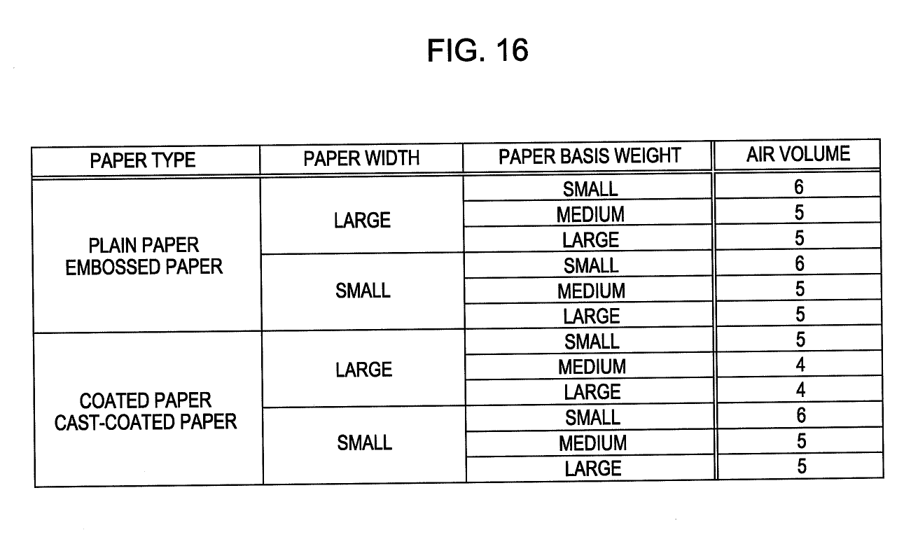

A controller 392 is provided as an example of a controller that controls the air volume of the fans 390. Referring to FIG. 16, when the recording medium P is a sheet of paper, the controller 392 controls the sucking force of the fans 390 to be constant regardless of the basis weight of the sheet, or the controller 392 controls the sucking force (the air volume) of the fans 390 to be greater if the basis weight of the sheet is small as compared with a case in which the basis weight of the sheet is large. The sucking force (the air volume) is increased as the numerical value indicative of the air volume in FIG. 16 is increased.

The controller 392 controls the sucking force of the fans 390 to be constant regardless of whether the recording medium P is normal paper or coated paper, or the controller 392 controls the sucking force of the fans 390 to be greater if the recording medium P is normal paper as compared with a case in which the recording medium P is coated paper.

Referring to FIG. 7A, the endless belts 334 and 338 are ring-like band members formed by weaving fibers 334A and 338A substantially in the forms of meshes (in the exemplary embodiment, 60 meshes/2.54 cm with a thickness of 280 μm and an opening area of 42%). The fibers 334A and 338A are molded with a resin material (in the exemplary embodiment, polyester resin with a line diameter of 150 μm). A weaving direction of the fibers 334A and 338A is oblique to the transport direction of the recording medium P (a direction indicated by arrow A in FIGS. 7A and 7B).

Since the weaving direction of the fibers 334A and 338A is oblique to the transport direction of the recording medium P, referring to FIG. 7B, the endless belts 334 and 338 are capable of stretching in the transport direction of the recording medium P. Also, since the endless belts 334 and 338 are substantially the meshes, sucking forces for sucking the air at an outer periphery side of the endless belts 334 and 338 into the air duct 340 through mesh holes 334B and 338B (openings) are substantially uniform over the outer peripheral surfaces of the endless belts 334 and 338. Unevenness in temperature of the recording medium P (the sheet member) due to the air sucked into the air duct 340 hardly occurs.

Joint portions generated when the endless belts 334 and 338 are formed into the ring-like shapes are made by heat sealing to be oblique to the transport direction of the recording medium P.

Further, the outer peripheral surfaces of the endless belts 334 and 338 are treated with surface processing (in the exemplary embodiment, a material for the surface processing is urethane resin), so that the outer peripheral surfaces of the endless belts 334 and 338 have a higher friction coefficient with respect to the transported recording medium P than a friction coefficient of the inner peripheral surfaces of the endless belts 334 and 338. It is to be noted that only the outer peripheral surfaces are treated with the surface processing to prevent an increase in rotation load due to friction between the inner peripheral surfaces of the endless belts 334 and 338 and the air duct and the like arranged in the endless belts 334 and 338 because the surface processing is applied to the inner peripheral surfaces. The color of the surface processing is black. Thus, contamination resulted from the developer or the like is not noticeable, and since the color of the fibers 334A and 338A is white, the front and back surfaces of the endless belts 334 and 338 may be easily distinguished by the color difference.

FIG. 6 illustrates the sheet-member transport device 108 when the air duct 340 is rotated around the driving roller 330. Referring to FIG. 6, limit members 394 protrude from a lower surface (a surface on which the recording medium P is not transported) of the upstream air duct 354. The limit members 394 contact end portions of the endless belts 334 and limit movement of the endless belts 334 in a direction orthogonal to the transport direction of the recording medium P (a thrust direction).

A tension roller 396 is provided so as to protrude from a lower surface of the downstream air duct 356. The tension roller 396 applies a tension to the endless belt 338. The tension roller 396 is accommodated in the recess 384 provided at the support member 380.

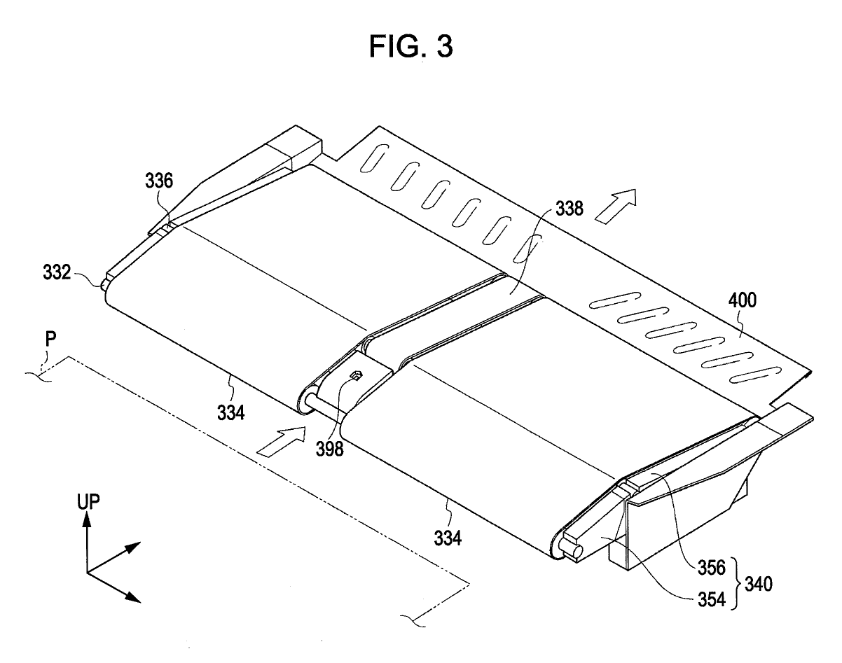

Referring to FIGS. 1 and 3, a sensor 398 is provided between the two endless belts 334. The sensor 398 is located upstream the endless belt 338 (at a position upstream the region between the driven roller 336 and the driving roller 330), in the upper surface of the upstream air duct 354. The sensor 398 detects the transported recording medium P.

A plate-like guide member 400 is provided downstream the endless belts 334 and 338. The guide member 400 guides the recording medium P transported by the endless belts 334 and 338, to the cooling unit (see FIG. 19).

### Operation

Referring to FIGS. 17 and 19, the toner images of the respective colors transferred on the intermediate transfer belt 34 in a superposed manner are secondarily transferred on the recording medium P transported by the second transfer roller 62. The recording medium P with the toner images transferred thereon is transported by the transport belts 70 to the sheet-member transport device 80 arranged upstream the fixing unit 82.

Referring to FIGS. 14 and 17, when the controller 316 of the sheet-member transport device 80 drives the motor 310, the driving roller 302 is rotationally driven. When the driving roller 302 is rotationally driven, the endless belts 306 are moved. The driven roller 304 is in contact with the moving endless belts 306, and rotated by the endless belts 306.

The controller 328 operates the fan 326. The fan 326 sucks the air in the air duct 308 and exhausts the air to the outside. The air is sucked into the air duct 308 through the plural openings provided in the upper surface of the air duct 308. When the air is sucked into the air duct 308 through the plural openings, the air at the outer periphery side of the endless belts 306 is sucked into the air duct 308 through the mesh holes 306B of the endless belts 306. Thus, the recording medium P from the transport belt 70 is transported while being attracted to the moving endless belts 306.

The recording medium P transported by the moving endless belts 306 while being attracted to the endless belts 306 contacts the discharging brush 320, and the recording medium P is guided to the fixing unit 82 by the plate-like guide member 318.

The fixing unit 82 fixes the toner images transferred on the surface of the recording medium P to the recording medium P by applying the heat and pressure to the toner images. Then, the fixing unit 82 transports the recording medium P to the sheet-member transport device 108.

Referring to FIGS. 4 and 17, when the controller 378 of the sheet-member transport device 108 drives the motor 344, the driving roller 330 is rotationally driven. When the driving roller 330 is rotationally driven, the endless belts 334 and 338 are moved. The driven rollers 332 and 336 contact the moving endless belts 334 and 338, and are rotated by the driven rollers 332 and 336.

Referring to FIG. 9, the controller 392 operates the fans 390. The fans 390 suck the air in the air duct 340 and exhaust the air to the outside. Accordingly, the air is sucked into the air duct 340 through the openings 358 and 360 (see FIG. 2) provided in the upper surface of the air duct 340.

More specifically, referring to FIGS. 9, 10, 11, 12, and 13, by operating the fans 390, the air around the upper surface of the upstream air duct 354 enters the upstream space 374 through the openings 358 (see FIG. 2), enters the lower space 370 through the opening 376, enters the spaces 382 through the openings 386 and 388, is sucked by the fans 390, and is exhausted to the outside.

The air around the upper surface of the downstream air duct 356 enters the upper space 368 through the openings 360 (see FIG. 2), enters the lower space 370 through the slit 372 provided in the rectifying plate 366, enters the spaces 382 through the openings 386 and 388, is sucked by the fans 390, and is exhausted to the outside.

When the air is sucked into the air duct 340 through the openings 358 and 360 (see FIG. 2), the air at the outer periphery side of the endless belts 334 and 338 is sucked into the air duct 308 through the mesh holes 334B and 338B of the endless belts 334 and 338. Accordingly, the transported recording medium P is attracted to the outer peripheral surfaces of the endless belts 334 and 338.

As a surface to be transported of the recording medium P sent from the fixing unit 82 is moved to the downstream side, the recording medium P gradually approaches the upper surfaces of the endless belts 334. The recording medium P is attracted to the moving endless belts 334 by the attracting force generated at the upper surface of the upstream air duct 354. The sensor 398 detects the transported recording medium P. The recording medium P is transported while being attracted to the mesh-like endless belts 334 and 338.

As described above, the outer peripheral surfaces of the endless belts 306, 334, and 338 are treated with the surface processing, and hence have the high friction coefficients with respect to the transported recording medium P.

In the above-described exemplary embodiment, the endless belts 306, 334, and 338 of the sheet-member transport devices 80 and 108 provided upstream and downstream the fixing unit 82 in the transport direction of the recording medium P are substantially the meshes. However, the meshes do not have to be applied to only the sheet-member transport devices at these positions. The meshes may be applied to another endless belt in a sheet-member transport device at another position (for example, the transport belt 70).

In the above-described exemplary embodiment, the controllers 316, 328, 378, and 392 are individually provided. However, a single controller may provide the respective controls.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet-member transport device, comprising:
an endless belt that is an endless band member formed by arranging fibers substantially in the form of a mesh, a surface at an outer periphery side of the endless belt being treated with surface processing so that the surface at the outer periphery side has a higher friction coefficient than a friction coefficient of a surface at an inner periphery side of the endless belt; and
at least two rotary members, the endless belt being wound around the rotary members, the rotary members being rotated to move the endless belt around the two rotary members.

2. The sheet-member transport device according to claim 1, further comprising:
an air duct that is provided at the inner periphery side of the endless belt and between the rotary members; and
a sucking member that sucks air to generate an air flow, the air being passed through the air duct, wherein a sheet member is attracted to the surface at the outer peripheral side of the endless belt with the air flow generated by the sucking member at the mesh of the endless belt.

3. The sheet-member transport device according to claim 1,
wherein a material of the fibers for forming the endless belt is polyester resin, and
wherein the surface processing is coating with polyurethane resin.

4. An image forming apparatus, comprising:
a heating and pressuring unit that heats and pressures a sheet member; and
the sheet-member transport device according to claim 1 used for at least one of a device that transports the sheet member to the heating and pressuring unit and a device that transports the sheet member output from the heating and pressuring unit to a downstream side in a transport direction of the sheet member.
